(19) United States
(12) Patent Application Publication
(10) Pub. No.: US 2010/0281671 A1
(43) Pub. Date: Nov. 11, 2010

(54) KIT FOR MOUNTING A PLAT TV AND A METHOD FOR MOUNTING A FLAT TV USING SUCH A KIT

(75) Inventor: Adrianus Johannes Stephanus Maria De Vaan, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/161,859

(22) PCT Filed: Jan. 24, 2007
(86) PCT No.: PCT/IB06/50237

§ 371 Date: Jul. 23, 2008

(30) Foreign Application Priority Data
Jan. 27, 2006 (EP) 06100922.1

(51) Int. Cl. B23P 19/04; F16M 13/02; H01F 7/00

(52) U.S. Cl. 29/428; 248/220.21; 248/206.5

(57) ABSTRACT

Kit for mounting a flat TV (1), comprising at least one foot (2) providing a vertical support and a horizontal connector (3) to be mounted on a wall, a stand (4) or the like and on the backside (1a) of the TV (1) for providing support in a horizontal direction. The invention further relates to a method for mounting a flat TV (1), using an abovementioned kit, wherein the method comprises: fixing a television part (3 a) to the backside (1a) of the flat TV (1) and fixing a mount part (3b) to a wall, a stand (4) or the like; connecting at least one foot (2) to a bottom of the flat TV (1); positioning the flat TV (1) by connecting the television part (3 a) to the mount part (3b) to provide a support in a horizontal direction; positioning of the at least one foot (2) on a surface providing vertical support.

The invention relates to a kit for mounting a flat TV.

Different mounting kits to mount a flat TV are known from practice. To mount a flat TV for instance on a wall, a mount can be provided which has to be screwed to the wall and whereto the flat TV is connected. To mount the flat TV with such a mount on a wall is difficult for an installer of the flat TV. Especially, when the flat TV comprises a large screen it is difficult to position the flat TV to the desired position due to its size and its weight. Furthermore, when the flat TV is brought to the desired position and mounted to the wall, it is not easy to reposition the flat TV in order to change the screen position, i.e. the viewing angle. In other cases, a difficult mechanism is required to enable the repositioning of the flat TV when already being in mounted position.

It is therefore an object of the invention to provide a kit for mounting a flat TV to a wall, a stand or the like, wherein it provides easy installing of the flat TV and at the same time enables easy repositioning of the flat TV.

In order to achieve this object, the kit according to the invention comprises at least one foot providing a vertical support and a horizontal connector to be mounted on a wall, a stand or the like and on the backside of the TV for providing support in a horizontal direction. Due to the vertical support, it is not necessary to hold the entire weight of the flat TV during mounting it on a wall or a stand. The weight of the flat TV only has to be held during bringing the flat TV towards its mounting position. When the flat TV is nearby the mounting position, the foot can be placed on a surface, immediately carrying a lot of weight. Then the flat TV has to be brought towards the wall or stand without holding the heavy weight, which eases the installation of the television.

According to a further elaboration of the invention, the horizontal connector comprises a television part adapted to be fixed to the backside of the flat TV and a mount part adapted to be fixed to the wall, the stand or the like. The mount part can be fixed to the wall on the desired position before installing the flat TV and the television part can be fixed to the backside of the flat TV before installing the flat TV. Both places can be accessed easily and therefore fixing both parts can be done quickly.

In further advantageous elaboration of the invention, the horizontal connector is a magnetic connector and preferably, the mount part comprises a magnetic element and the television part comprises a metal element or vice versa. Due to this configuration, during mounting the flat TV, the magnetic force of the magnetic element helps to connect the television part to the mount part. When the television part approaches the mount part, the magnetic force pulls the flat TV towards the mounting position and keeps the TV in that position. To reposition the flat TV the horizontal connector can stay in connected position. The magnetic connector enables rotating of the television part relatively to the mount part. After lifting the bottom of the flat TV off the surface, where it rests on in mounted position, the flat TV can be rotated. When the flat TV reaches the desired position, the feet connected to the bottom of the flat TV are put on the surface again.

The invention further relates to a method for mounting a flat TV, using an abovementioned kit, wherein the method comprises:
fixing a television part to the backside of the flat TV and fixing a mount part to a wall, a stand or the like;
connecting at least one foot to a bottom of the flat TV;
positioning the flat TV by connecting the television part to the mount part to provide a support in a horizontal direction;
positioning of the at least one foot on a surface providing vertical support.

This method provides the same kind of advantages as the aforementioned kit for mounting a flat TV.

The invention also relates to a system comprising a kit according to the invention and a flat TV mounted or mountable to the kit.

The invention will be further elucidated by means of exemplary embodiments with reference to the accompanying drawings in which:

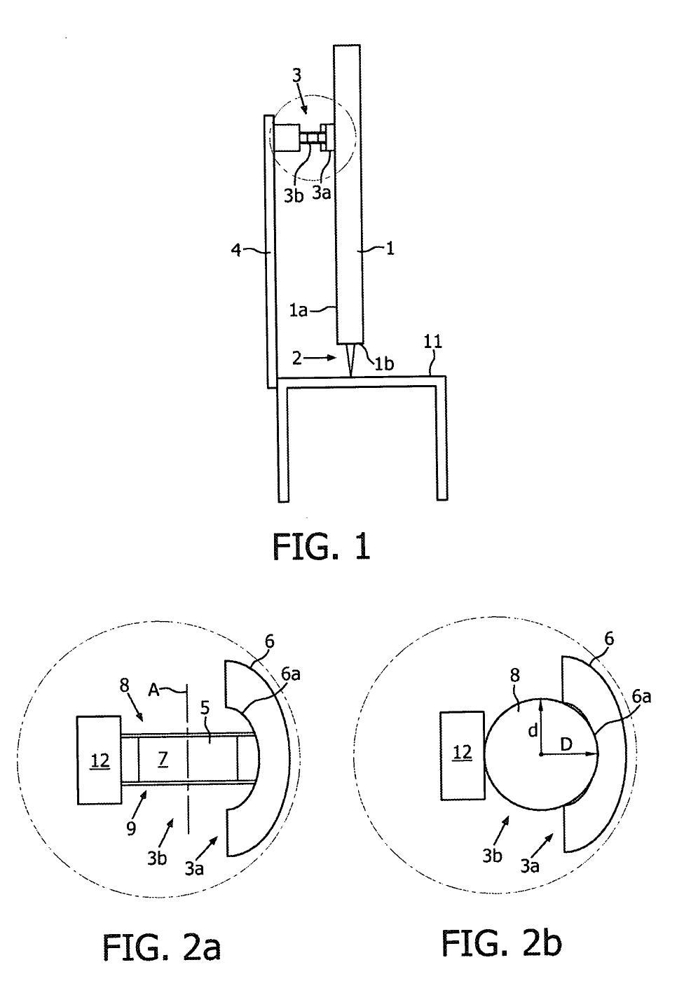

FIG. 1 shows a side view of a flat TV mounted on a stand;

FIGS. 2a and 2b show a side and top view of a detail of FIG. 1;

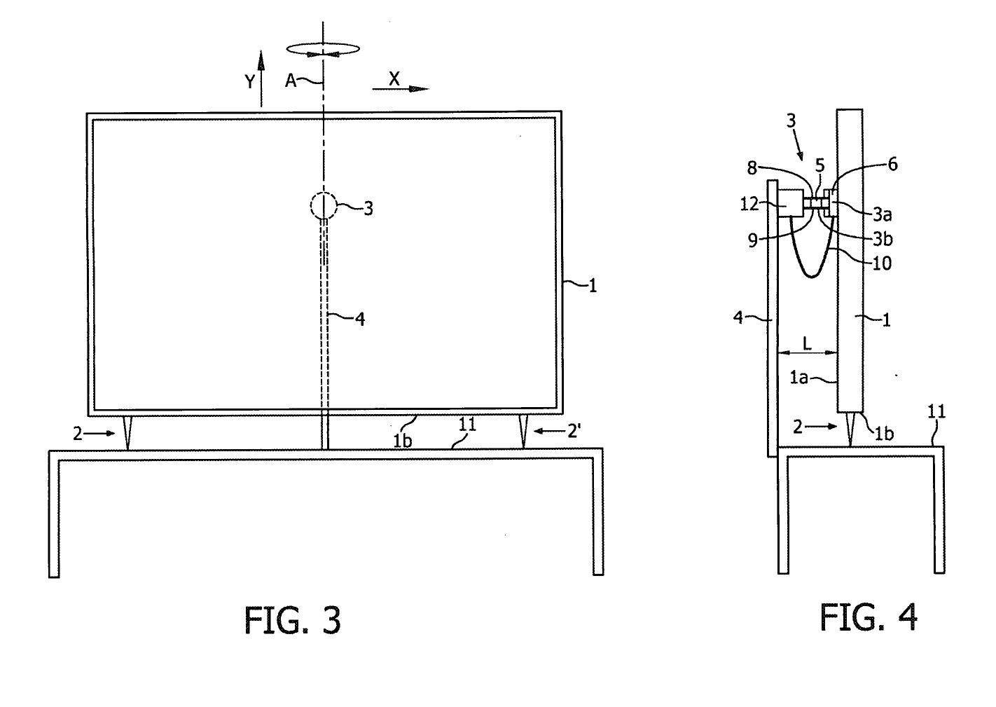

FIG. 3 shows a front view of a flat TV mounted on a stand; and

FIG. 4 shows another side view of a flat TV.

In the Figs similar reference numerals refer to similar parts.

In FIG. 1 a side view of a flat TV 1 mounted on a stand is shown. The flat TV 1 is mounted on the stand 4 with aid of a kit for mounting a flat TV 1. The kit comprises two feet 2, 2′ for providing a vertical support. The kit further comprises a horizontal connector 3, which is mounted on a stand 4 and on the backside 1a of the TV 1 for providing support in a horizontal direction.

The horizontal connector 3 comprises a television part 3a adapted to be fixed to the backside 1a of the TV 1 and a mount part 3b to be fixed to the stand 4. The mount part 3b is also suitable for fixing on a wall or another kind of vertical surface.

To install the flat TV 1 to a stand 4 or a wall or the like, the television part 3a is fixed to the backside 1a of the flat TV 1, for instance with aid of screws or other fixing means. The mount part 3b is fixed to the desired position to the stand 4 or a wall, also with screws or other fixing means. The feet 2, 2′ are connected to the bottom 1b of the flat TV 1. Then the flat TV is brought to the stand 4 by lifting the flat TV and positioning the flat TV by connecting the television part 3a to the mount part 3b to establish the horizontal connection. The feet 2, 2′ are positioned on a surface 11 for vertical support. It should be clear that it is also possible to put the feet 2, 2′ on the surface 11 before establishing the horizontal connection. While making that connection a lot of weight of the flat TV rests on the surface enabling easier mounting the TV 1 to the stand 4.

After mounting the flat TV 1, the TV 1 seems to be floating above the surface 11 and in front of the wall resulting in an aesthetic look and at the same time providing a strong and stable fixture.

FIGS. 2a and 2b provide a side view and a top view of the horizontal connector 3, respectively. The horizontal connector 3 is a magnetic connector. In FIG. 2a can be seen that the mount part 3b of the horizontal connector 3 comprises a magnetic element 5 having a magnet 7 situated between to two plates 8, 9. The plates 8, 9 extend substantially parallel and preferably are metal plates. The mount part 3b further comprises fastening means 12 to fasten the mount part 3b to a stand, a wall or the like. The television part 3a comprises a metal element 6. In another embodiment of the invention it is possible that the television part 3a comprises a magnetic element 5 and the mount part 3b comprises a metal element 6. Also two horizontal connectors 3 can be provided to mount the TV 1 to a wall or a stand 4.

When repositioning the TV 1, the feet 2 are lifted and the TV is turned around axis A to a new desired position. The horizontal connector 3 stays connected. The shape of the magnetic element 5 and the metal element 6 enables easy rotation around axis A as can be seen in FIG. 2b. Therefore, diameter d of plates 8, 9 having a substantially circular circumference corresponds to the diameter D of the substantially concave spherical surface 6a of the metal element 6. The concave spherical surface 6a faces the magnetic element 5 and is arranged to cooperate with the magnet element 5.

FIG. 3 shows a front view of a flat TV 1 mounted on a stand 4 with aid of a kit according to the invention. The feet 2, 2′ are connected to the bottom 1b of the flat TV 1 and provide a vertical support on the surface 11. Due to the horizontal connector 3 that is provided in the middle of the flat TV, seen in X-direction, the TV 1 can easily rotate around axis A. First, the feet 2, 2′ are lifted in direction Y and without much effort the viewing angle of the flat TV 1 can be changed. The magnetic force of the horizontal support holds the TV 1 during repositioning, which therefore helps the user by holding a lot of weight.

FIG. 4 shows another side view of the flat TV 1 in mounted position. A security element 10, for instance a chain, is attached to the mount part 3b and to the television part 3a of the horizontal connector 3. This security element 10 secures the flat TV and prevents it from dropping down if the magnetic horizontal connection 3 might fail, for instance by a mechanical shock. Because the chain is longer than the distance L between the stand 4 and the backside 1a of the flat TV 1, the chain can be easily connected to both parts 3a, 3b.

Although illustrative embodiments of the present invention have been described in greater detail with reference to the accompanying drawings, it is to be understood that the invention is not limited to these embodiments. Various changes or modifications may be effected by one skilled in the art without departing from the scope or the spirit of the invention as defined in the claims. For instance the magnet connection can also be a different kind of connection providing the same kind of advantages as the magnetic connection. Also a different kind of vertical support can be used and a different way of rotating the flat TV can be possible.

1. Kit for mounting a flat TV (1), comprising at least one foot (2) providing a vertical support and a horizontal connector (3) to be mounted on a wall, a stand (4) or the like and on the backside (1a) of the TV (1) for providing support in a horizontal direction.

2. Kit according to claim 1, wherein the horizontal connector (3) comprises a television part (3a) adapted to be fixed to the backside (1a) of the flat TV (1) and a mount part (3b) adapted to be fixed to the wall, the stand(4), or the like.

3. Kit according to claim 1, wherein the horizontal connector (3) is a magnetic connector.

4. Kit according to at least claim 3, wherein the mount part (3b) comprises a magnetic element (5) and the television part (3a) comprises a metal element (6) or vice versa.

5. Kit according to claim 1, wherein the magnetic element (6) comprises a magnet (7) situated between two plates (8, 9), the plates (8, 9) extending substantially parallel.

6. Kit according to at least claim 5, wherein the plates (8, 9) have a substantially circular circumference.

7. Kit according to claim 5, wherein the plates (8, 9) are metal plates.

8. Kit according to at least claim 4, wherein the metal element (6) has a substantially concave spherical surface (6a), being the surface facing the magnetic element (5), wherein the spherical surface (6a) is arranged to cooperate with the magnetic element (5).

9. Kit according to claim 1, wherein the at least one foot (2) for vertical support is connectable to the bottom (1b) of the flat TV (1), adapted to rest on a surface (11).

10. Kit according to claim 1, wherein the kit comprises a security element (10), for instance a chain, for securing the flat TV (1) to the wall or the stand (4) to prevent it from dropping down.

11. Method for mounting a flat TV, using a kit according to claim 1, wherein the method comprises:
fixing a television part (3a) to the backside (1a) of the flat TV (1) and fixing a mount part (3b) to a wall, a stand (4) or the like;
connecting at least one foot (2) to a bottom (1b) of the flat TV (1);
positioning the flat TV (1) by connecting the television part (3a) to the mount part (3b) to provide a support in a horizontal direction;
positioning of the at least one foot (2) on a surface (11) providing vertical support.

12. Method according to claim 11, wherein the method further comprises securing the flat TV (1) to the wall, stand (4) or the like by fastening a security element (10) thereto and to the backside (1b) of the flat TV (1).

13. System comprising a kit according to claim 1 and a flat TV.
